(19) United States
(12) Patent Application Publication
(10) Pub. No.: US 2011/0256513 A1
(43) Pub. Date: Oct. 20, 2011

(54) SPEECH COMPREHENSION TRAINING SYSTEM, METHODS OF PRODUCTION AND USES THEREOF

(76) Inventors: Harry Levitt, Bodega Bay, CA (US); Christopher Oden, Bronx, NY (US)

(21) Appl. No.: 13/039,647

(22) Filed: Mar. 3, 2011

Related U.S. Application Data
(60) Provisional application No. 61/310,145, filed on Mar. 3, 2010.

(51) Int. Cl. G09B 19/04

(52) U.S. Cl. 434/185

(57) ABSTRACT

Auditory training systems are disclosed and include at least one speech perception activity, and at least one audio signal, at least one video signal or a combination thereof, wherein the system is user interactive, performance adaptive or a combination thereof. Methods of training and improving auditory skills, cognitive skills or a combination thereof includes providing a computer, internet-based system, server-based system or another hardware device, providing an executable software system that provides at least one speech perception activity, providing at least one audio signal, at least one video signal or a combination thereof, wherein the system is user interactive, performance adaptive or a combination thereof and wherein the computer, Internet-based system, server-based system or another hardware device executes the software system to initiate and run the auditory training system; and utilizing the computer, internet-based system, server-based system or another hardware device to execute the executable software system that provides at least one speech perception activity in combination with the at least one audio signal, at least one video signal or a combination thereof.

This United States Utility Application claims priority to U.S. Provisional Patent Application Serial No. 61/310,145 filed on Mar. 3, 2010, which is commonly-owned and incorporated herein in its entirety by reference.

### BACKGROUND

Hearing loss is one of the most common handicapping conditions today. It has been estimated that as much as 10 percent of the population have a hearing loss of some kind (Schein and Delk, 1974). This proportion has not changed significantly over the years. A recent estimate by the hearing aid industry indicates that, as of 2009, 31.5 million Americans were hard of hearing (Kotchkin, 2009). What has changed significantly in recent years is the rapidly growing use of cochlear implants by people with severe or profound hearing loss. The number of cochlear implants has grown by 20 percent per year over the past five years. One company alone has already provided over 120,000 individuals with a cochlear implant (see Cochlear Corporation website www.cochlearamericas.com).

The incidence and severity of hearing loss increase with advancing age. In particular, the percentage of people using hearing aids increases rapidly after 45 years of age. La Plante et al. (1992) found that less than 10 percent of hearing aid users are under 45 years of age and that this percentage doubles to almost 20 percent for hearing-aid users in the 45-to-64 age range. The percentage doubles once again for hearing aid users over 75 years of age.

Only a small proportion of the population that could benefit from acoustic amplification actually use hearing aids. Many older people who have acquired hearing losses later in life are reluctant to obtain hearing aids. A common problem is that adults who have been fitted with hearing aids are often too busy (and/or reluctant) to attend classes in auditory rehabilitation. For those who are motivated but are too busy to attend regular classes at a clinic, a home-based system for practice and self training with a few well placed visits to a clinic to monitor progress would be of great value. Another problem is that structured training programs can be boring and a high degree of motivation is needed to use training programs of this type over long periods of time.

Visual speech cues play an important role in face-to-face communication when the auditory signal is degraded as a result of a hearing loss and/or the addition of noise, reverberation or other distortions. Visual speech cues complement, to a large extent, the auditory cues that are lost in the impoverished speech signal. The auditory cues signaling place of articulation, for example, are quite subtle while the corresponding visual speech cues are far more prominent. The auditory cues signaling manner of articulation are not as subtle as those for place of articulation and are less subject to error. The visual cues for manner of articulation, in contrast, are more subtle than those for place of articulation. The complementary nature of visual and auditory speech cues is even more striking with respect to voicing. The voicing contrast is relatively easy to perceive auditorially even for people with some degree of hearing loss, but is very difficult to detect visually.

There are two basic approaches to speech reception training, the analytic approach and the synthetic approach (Schow and Nerbonne, 2002). In the analytic approach, the emphasis is on training the student to recognize the individual sounds of speech (or in the case of visual speech recognition, to recognize the articulatory gestures associated with individual sounds). It is assumed that with improved recognition of the components of speech, improved recognition of words, phrases and sentences will follow. The synthetic approach, in contrast, emphasizes training to recognize the meaning of what is said even if individual speech components are not recognized. This approach places much greater emphasis on the use of context.

There are also different approaches with respect to the use of auditory and/or visual cues in rehabilitation training. The approaches vary from the use of audition only (Pollack, 1970) to the opposite extreme of withholding or attenuating auditory cues during speechreading training (Jeffers and Barley, 1971) to an emphasis on integrating visual and auditory cues (Garstecki, 1982). A training technique that emphasizes the integration of all available cues, audition, vision, and context, as well as possible repair strategies, is that of Continuous Discourse Tracking ((DeFilippo and Scott, 1978; DeFilippo, 1988).

The experimental evidence on the effectiveness of auditory training in improving speech reception skills is strongest for hearing impaired individuals who have great difficulty understanding speech and who receive substantial amounts of auditory training. In a classic study sponsored by the National Research Council, an average increase on the order of 30 percentage points in speech recognition scores was obtained for both “partially deaf” and “profoundly deaf” students over a five year period, most of the improvement being obtained after two years of training (Hudgins, 1954). Similarly, substantial long term improvements in speech reception ability have been obtained with cochlear implant patients receiving significant amounts of auditory training (Clark, 2003).

The effect of long-term training on speech reception skills with moderately hearing impaired adults has not been studied to the same extent. Small gains in speechreading ability have been reported by Walden et al (1977, 1981) for intensive training after a relatively short period of time. Similarly, Kricos and Holmes (1996) have shown small improvements in auditory training with older adults. Recent research by Humes, et. al. (2009) has also shown significant improvements in speech recognition in noise with auditory training. A related issue is that of acclimatization to acoustic amplification. Gatehouse (1993) has shown that at least six weeks of exposure to a new hearing aid is needed before acclimatization shows significant improvements in speech reception.

There have been few experimental studies comparing the analytic and synthetic approaches to speech reception training. Of the few studies that have been reported, Boothroyd, et al. (1987) compared the two procedures with 5 adult subjects fitted with cochlear implants. The subjects were found to benefit more from the synthetic approach using sentence materials. There is, however, a substantial overlap between the two approaches in practice. Implementation of the analytic approach is often followed by the synthetic approach once some degree of mastery at the analytic level has been achieved. Similarly, implementation of the synthetic approach usually begins with an introduction to the different sounds of speech.

Blarney and Alcantara (1994) in a review of auditory training procedures point out that success in auditory training is dependent on a number of complex variables, the most important being the degree of difficulty in understanding speech, the motivation for improved understanding, evidence of progress (i.e., success breeds success), the amount of auditory training and the appropriateness of the auditory training program for each individual's needs. In view of the above it is surprising that more attention has not been given to the problem of auditory training in a noisy environment for adult hearing aid users. Difficulty in understanding speech in noise is extremely common among hearing aid users, hearing aids are not particularly helpful in a noisy environment, and many hearing aid users simply switch off their instruments in a noisy environment. In this case, lack of success breeds lack of success. This lack of success is also partly responsible for the large number of people with significant hearing loss who do not use hearing aids in the belief that hearing aids will be of little if any benefit.

Computer-based techniques provide an efficient means of speech reception training for students with hearing loss. Such training methods have many advantages (Sims and Gottermeier, 2000). These include adaptive matching of the training program to the user's needs and level of competence, using novel and interesting displays, providing unobtrusive objective monitoring of student progress and, in addition, providing the designer of the training system information on those aspects of the system that need to be improved.

The Dynamic Audio Visual Interactive Device (DAVID) first developed in 1973 has been used successfully at the National Technical Institute for the Deaf for many years. A more recent application of computer based training is Seeing and Hearing Speech developed by Sensimetrics.

Another recent development using a computer-interactive training technique is the Listening and Auditory Communication Enhancement (LACE) program developed by Sweetow and his colleagues. Significant improvements in objective evaluations with appropriate controls have been reported by. Sweetow and Sabes (2004, 2006) in evaluating this training program and a major hearing aid company, Starkey Laboratories, has begun to distribute LACE. This is a welcome development and it is a sign that major hearing aid companies are beginning to pay more attention to the importance of aural rehabilitation in acoustic amplification.

The revival of interest in aural rehabilitation has been driven in part by pressure from funding sources to demonstrate cost-effectiveness with appropriate outcome measures. Chisholm et al (2004) and Hawkins (2005) have reviewed the short- and long-term outcomes of adult aural rehabilitation and have documented the positive outcomes, such as reduction in self-perception of hearing handicap and better use of hearing aids and communication strategies.

To summarize the background, people who use hearing aids or hearing amplifiers to improve their ability to hear are faced with several issues, and in some instances disadvantages, including a) reliance on use of a device for all hearing improvements; b) inability to understand conversations in crowded and/or noisy environments; c) the number of people with hearing loss requiring aural rehabilitation is substantial, on the order of millions; and d) conventional aural training programs are prohibitively expensive. As a result, many hearing-disabled individuals are falling behind the curve on improving their comprehension skills, and unfortunately, skills that are not utilized on a regular basis tend to atrophy. There is a growing awareness of the need for more effective methods of aural rehabilitation. At the same time, there is also a need for the development of practical computer-based techniques that offer the means for achieving this goal.

An effective way of improving speech reception skills, including cognitive skills, is to exercise these skills as much as possible. To this end, it would be ideal to develop a system that makes methods of auditory training entertaining so that students will want to use the system for long periods of time, thereby getting substantial practice in honing auditory and auditory-visual speech reception skills without being bored. A system that is fun to use will not only maintain motivation but will also serve as an enticement for students to use the system more often and for long periods of time thereby improving their speech reception skills. In addition, it would be ideal to make such a system an interactive adaptive procedure that will be used so as to automatically match the training material to the user's needs and level of performance.

The user's rate of progress will be monitored objectively, which in some embodiments can include online tracking of progress that may be monitored by a professional, and the system will provide appropriate positive reinforcement to continue to maintain motivation. The system could be configured around a moderately priced personal computer, or internet enabled device so that it would be affordable and convenient to use at home, such as an inexpensive DVD- or web-browser-based version of the system. To meet these goals, a system has been developed and evaluated experimentally. It is described herein and addresses all of the needs and provides additional functionality.

### SUMMARY OF THE SUBJECT MATTER

Auditory training systems are disclosed and include at least one speech perception activity, and at least one audio signal, at least one video signal or a combination thereof, wherein the system is user interactive, performance adaptive or a combination thereof.

An executable software system is disclosed for auditory training and provides at least one speech perception activity, and at least one audio signal, at least one video signal or a combination thereof, wherein the software is user interactive, performance adaptive or a combination thereof.

An auditory training system that includes a computer, internet-based system, server-based system or another hardware device, an executable software system that provides at least one speech perception activity, and at least one audio signal, at least one video signal or a combination thereof, wherein the system is user interactive, performance adaptive or a combination thereof and wherein the computer, internet-based system, server-based system or another hardware device executes the software system to initiate and run the auditory training system.

Methods of training and improving auditory skills, cognitive skills or a combination thereof, includes: providing at least one speech perception activity, providing at least one audio signal, at least one video signal or a combination thereof, wherein the system is user interactive, performance adaptive or a combination thereof; and utilizing the at least one speech perception activity in combination with the at least one audio signal, at least one video signal or a combination thereof in order to improve auditory skills, cognitive skills or a combination thereof.

Methods of training and improving auditory skills, cognitive skills or a combination thereof includes providing a computer, internet-based system, server-based system or another hardware device, providing an executable software system that provides at least one speech perception activity, providing at least one audio signal, at least one video signal or a combination thereof, wherein the system is user interactive, performance adaptive or a combination thereof and wherein the computer, internet-based system, server-based system or another hardware device executes the software system to initiate and run the auditory training system; and utilizing the computer, internet-based system, server-based system or another hardware device to execute the executable software system that provides at least one speech perception activity in combination with the at least one audio signal, at least one video signal or a combination thereof.

### BRIEF DESCRIPTION OF THE FIGURES

FIG. 1 is an example of a contemplated speech perception activity, which is a cross-sentence puzzle in this embodiment.

FIG. 2 shows the decrease in Speech-to-Noise Ratio for 50% Intelligibility. The subjects are shown in order of decreased speech-to-noise ratio (i.e., improved performance). Subjects 1 to 9 are experienced hearing-aid users. The vertical bars show the average test-retest standard error for the observed increase in speech-to-noise ratio.

FIG. 3 shows the duration and frequency of Use. Each bar corresponds to a time interval during which the system was used in a training session. The height of each bar corresponds to the frequency with which the system was used for that time interval. The data are for all 10 subjects. Note that on a few occasions the system was used continuously within a training session for as much as two hours or more.

FIG. 4 shows correlation of Speech-to-Noise Ratio with Time on Task. Time on Task is equal to the total time spent by each subject on the training system during the training program. Correlation coefficient=0.61 (p=0.6, 8 df)

FIG. 5 shows test scores showing progress during the training program.

FIG. 6 shows a contemplated typical puzzle menu for difficulty level 4.

FIG. 7 shows a contemplated method of training and improving auditory skills, cognitive skills or a combination thereof.

FIG. 8 shows a contemplated method of training and improving auditory skills, cognitive skills or a combination thereof.

### DETAILED DESCRIPTION

Specifically, auditory training systems are disclosed and include at least one speech perception activity, and at least one audio signal, at least one video signal or a combination thereof, wherein the system is user interactive, performance adaptive or a combination thereof. As used herein, the term “auditory” refers to speech reception or speech comprehension, and an “auditory training system” is one that uses audio, video or a combination thereof to identify, assess and ultimately improve auditory and auditory-visual speech reception skills and cognitive skills, such as speech and language. In some contemplated embodiments, auditory training systems also include at least an amount of interference, distortion or a combination thereof of the speech signal so as to adjust the difficulty with which speech is perceived, such as background noise.

The concepts of user interactive and performance adaptive are important in the scope of contemplated embodiments. Contemplated systems and software are not merely “read only” or one-way systems, but are designed to be two-way systems, in that the user responds to and interacts with the system and/or software. Therefore, information is being provided to the user from the system and in response, the user is providing responsive information to the system. Contemplated systems may also be performance adaptive. This important concept is one of the keys to the ability of the user to improve during the use of the system and/or software. Performance adaptation means that the system and/or software processes the information provided by the user and utilizes that information to both a) determine the current skill level of the user and b) chart an individual course of action for the user to move the use to the next milestone. In the case of manual embodiments, as described later, the information provided by the user includes information that the user is ready to transition to the next difficulty level. In the case of internet or server-based systems, the information provided by the user comprises either or both of the answers and feedback to the activities and/or information that the user is ready to transition to the next difficulty level.

An executable software system is disclosed for auditory training and provides at least one speech perception activity, and at least one audio signal, at least one video signal or a combination thereof, wherein the software is user interactive, performance adaptive or a combination thereof.

An auditory training system that includes a computer, internet-based system, server-based system or another hardware device, an executable software system that provides at least one speech perception activity, and at least one audio signal, at least one video signal or a combination thereof, wherein the system is user interactive, performance adaptive or a combination thereof and wherein the computer, internet-based system, server-based system or another hardware device executes the software system to initiate and run the auditory training system. It is contemplated that the term “executes” means either executes directly or executes indirectly through a series of other commands, language or software.

Methods of training and improving auditory skills, cognitive skills or a combination thereof, includes: providing at least one speech perception activity, providing at least one audio signal, at least one video signal or a combination thereof, wherein the system is user interactive, performance adaptive or a combination thereof; and utilizing the at least one speech perception activity in combination with the at least one audio signal, at least one video signal or a combination thereof in order to improve auditory skills, cognitive skills or a combination thereof.

Methods of training and improving auditory skills, cognitive skills or a combination thereof includes providing a computer, internet-based system, server-based system or another hardware device, providing an executable software system that provides at least one speech perception activity, providing at least one audio signal, at least one video signal or a combination thereof, wherein the system is user interactive, performance adaptive or a combination thereof and wherein the computer, Internet-based system, server-based system or another hardware device executes the software system to initiate and run the auditory training system; and utilizing the computer, internet-based system, server-based system or another hardware device to execute the executable software system that provides at least one speech perception activity in combination with the at least one audio signal, at least one video signal or a combination thereof.

In some embodiments, an executable software system is disclosed for auditory training and provides at least one puzzle, and at least one audio signal, at least one video signal or a combination thereof, wherein the software is user interactive and performance adaptive. Also, in some embodiments, contemplated puzzles comprise at least one “cross-sentence puzzle”.

In some embodiments, an auditory training system includes a computer, an internet-based system, a server-based system or another hardware device, an executable software system that provides at least one puzzle, and at least one audio signal, at least one video signal or a combination thereof, wherein the software is user interactive and performance adaptive and wherein the computer, internet-based system, server-based system or another hardware device executes the software system to initiate and run the auditory training system.

As mentioned, a core component of a contemplated system, as described herein, is a speech perception activity, which is designed to engage and challenge the user through at least one puzzle, game or other interactive activity in order to improve auditory perception and overall auditory and/or cognitive skills. These contemplated speech perception activities may comprise audio signals, video signals or a combination thereof.

In some embodiments, a contemplated speech perception activity is a “cross-sentence” puzzle. A contemplated puzzle is similar to a crossword puzzle except that answers to the puzzle items consist of short sentences or phrases instead of single words. Each clue in the puzzle consists of text in which a phrase or sentence is missing. The subject is provided with the answer in the form of a video recording of the text including the missing sentence or phrase. In order to solve the item, it is necessary for the listener to integrate the auditory and visual information conveyed by the video recording with the contextual cues provided by the text. For auditory training without visual cues, the video signal is suppressed and the audio channel only is used. Background noise is one contemplated method or technique that is used to control the difficulty of each puzzle item. Other methods of controlling the difficulty of a puzzle item is to add reverberation to the speech signal, or speed up the rate at which the speech is produced, or to distort the speech signal in other ways.

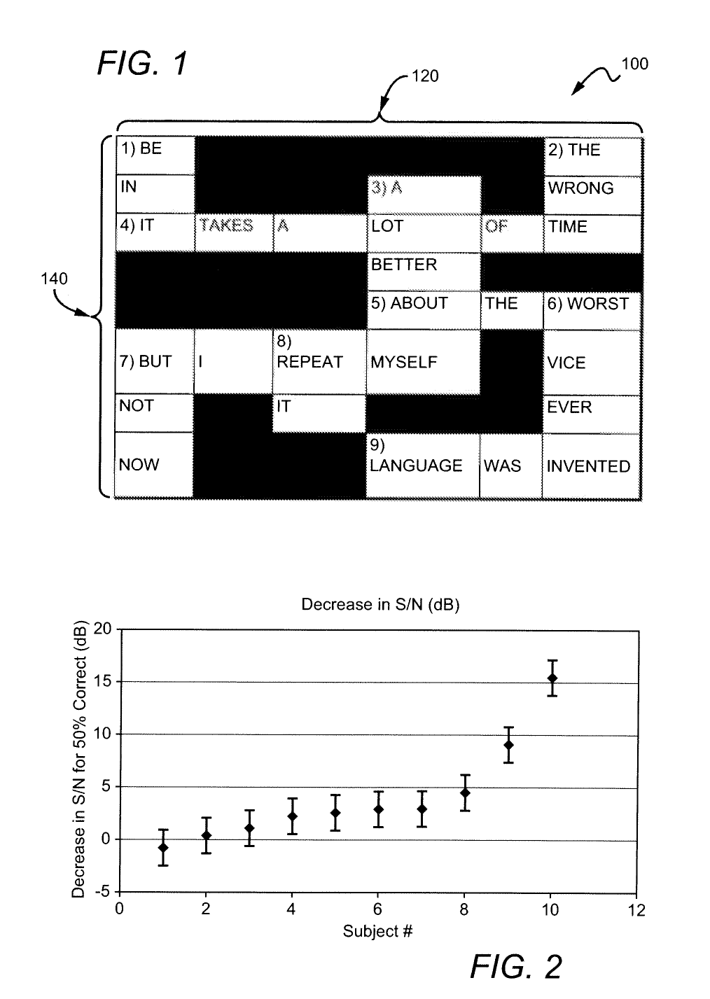

The technique is best described through an example. FIG. 1 shows a sketch of a simple puzzle 100 consisting of 2 items across 120 and 6 items down 140. The puzzles used in the initial experimental evaluation were much larger consisting of 20 to 30 items per puzzle. The puzzle is displayed graphically on a computer monitor (not shown). Initially, all of the open squares in the puzzle are empty. The subject selects a puzzle item by clicking on an empty row or column. The clue for the puzzle item is then shown as a caption on the computer monitor. For example, clicking on any square in the third row, the clue for item #4 across appears as a caption on the computer monitor: “ ______ to prepare a good impromptu speech.” The six dashes correspond to the six open squares for item #4. After clicking the computer mouse a second time, a video recording of a person producing the entire sentence appears above the caption: “It takes a lot of time to prepare a good impromptu speech.” The speech is masked by noise so that it is not easy to recognize what was said.

The subject's task is to combine the auditory-visual information provided by the noisy video recording with the sentence context contained in the caption in order to solve the item. The subject enters what he/she perceives as the missing words via the computer keyboard. The solution to this puzzle item is: “It takes a lot of time”. If the correct words have been entered by the subject, they appear in bold black letters in the appropriate squares of the puzzle. Incorrect words appear in red. If the subject is unable to solve this item at this stage, he/she may try another item, as is the usual strategy in solving crossword puzzles. If the subject goes on to solve items #1, #2 and #3 down, the words “it”, “lot” and “time” will appear in the row for #4 across, thereby making this item easier to solve the next time it is attempted.

The nine puzzle items and their solutions are presented here for the reader's interest.

#1 down

Clue: “Where there's a will I want to ______”

Solution: “be in it”

#2 down

Clue: “A blunder at the right moment is better than cleverness at ______”

Solution: “the wrong time” (Carolyn Wells, author)

#3 down

Clue: “Delusions of grandeur make me feel ______”

Solution: “a lot better about myself” (Jane Wagner, humorist)

#4 across

Clue: “ ______ to prepare a good impromptu speech”

Solution: “It takes a lot of time” (after Mark Twain)

#5 across

Clue: “Competition brings out the best products and in people ______”

Solution: “about the worst” (David Sarnoff)

#6 down

Clue: “Good taste is the ______”

Solution: “worst vice ever invented” (Edith Sitwell)

#7 across

Clue: “Suppose you were an idiot. And suppose you were a member of Congress ______”

Solution: “but I repeat myself” (Mark Twain)

#7 down

Clue: “Conservatives believe in reform, ______”

Solution: “but not now” (Mort Sahl)

#8 down

Clue: “Experience lets you recognize a mistake when you ______”

Solution: “repeat it”

#9 across

Clue: “ ______ to satisfy our deep need to complain”

Solution: “Language was invented” (Lily Tomlin)

In order to solve the speech perception activity, which is a cross-sentence puzzle in this embodiment, the subject is required to make maximum use of his/her speech reception skills. Therefore, it is important for the puzzle to be challenging but not overly difficult, which is accomplished by adjusting the level of background noise (cafeteria noise that had been equalized in level over time) adaptively to match the subject's performance level. Initially, this was done by decreasing the noise level after each incorrect entry and increasing the noise level if all of the missing words are entered correctly. Subsequently, a number of more refined adaptive methods were evaluated. These include:
Averaging the subjects performance over several attempts to reduce the effect of outliers (i.e. utterances that were particularly easy or difficult).
Weighting the averages based on the number of words correctly identified on a given attempt, in order to obtain a more accurate measure of the level at which the listener was able to understand some of the utterance.
Further weighting the average by various measures of the difficulty of individual attempts, including:
   The amount of context (number of words to be identified relative to number of words visible as clues).
   The relative difficulty of understanding a particular speaker, determined over the course of the experiment.
   The relative difficulty of the item to be identified (as measured by word length, concentration of difficult visemes/phonemes, and experimental data).
   The amount of time taken to complete the attempt.
   The number of attempts necessary to complete a particular item.
Adjusting the step size dynamically. A much faster rate of convergence can be obtained using a variable step size. A variation of the Robbins Monro method of adjusting step size has been found to converge rapidly and reliably on the target level (Robbins and Monro 1951; Levitt 1971).
Allowing the listener to modify the noise level manually on a given attempt.

A further refinement of a contemplated system has been the development and inclusion of instructional material focused on the synthetic approach to training. The listener is periodically presented with short paragraphs telling her how to improve her listening skills, which she can then practice as she works through the puzzles.

The software also keeps a detailed record of each student's progress. The data record includes the puzzle item chosen for each trial, the number of times each video recording is played back on each trial, the response time for each playback, the speech-to-noise ratio on each playback and the words correctly identified on each playback. A test score equal to a weighted average of the speech-to-noise ratio when the puzzle item is solved and the time taken to solve the item. This test score is provided as feedback to the subject to indicate how well they are doing. All the collected data are analyzed to fine-tune the system by determining relative difficulty of the items and speakers, and the kind of instructional material provided. The data can also be analyzed and presented to rehabilitation professionals, thus helping them to monitor the progress and customize the treatment of their patients.

The problem of spelling errors in the listener's typed responses was addressed by using a public domain spell-check engine in an innovative way. In this application, we want to accept misspellings of the target word, but only if they do not represent a misunderstanding of the utterance; that is, only if they are not valid words in themselves. For example, “bin” and “bun” are spelled similarly, but represent very different concepts. On the other hand, “bin” and “bim” are also spelled similarly, but “bim” isn't a word. Most spell-check engines provide a metric of confusion which describes how easily confused lexically one word is with another. Knowing this, and the target word, we were able to evaluate a response as follows:
If the metric of confusion was low (response not similar to target), the guess was marked as incorrect.
If the metric of confusion was high (response similar to target) but the response was not a word, the guess was marked as correct after spell-check
If the metric of confusion was high (response similar to target) but the response was a word, the listener was informed that her response was “very close”.

### Preparation of Training Material

A large number of speech perception activities are needed, including cross-sectional puzzles, to provide many hours of intensive speech-reception training. In order to prepare large numbers of activities and/or puzzles rapidly and efficiently a computer program was developed for generating cross-sentence puzzles from a large database of puzzle items. The program operated in the following way. An initial puzzle item is entered into the computer. The computer then searches for short sentences or phrases in the database containing words that are common to the initial item. The possible items are then ranked in order of how many words each item contains that is common to other words in the database. The entry with the highest number of common words with other words in the database is then selected to be the next puzzle item since it is likely to have more intersections than any other possible item. The computer then searches the database for the next set of possible items, and so on. The process is continued until a puzzle with 20 to 30 items is obtained.

A compendium of thousands of witty sayings, clever quotations and comedic punch lines was compiled and indexed. Then, 15 puzzles were generated for use in a feasibility study. Subsequently, 24 additional puzzles were generated for a much larger study and product deployment. All the puzzles were double-checked to make sure that there were no inappropriate items (i.e., items with racist, sexist or off-color content were excluded). Video recordings were made of the selected puzzle items by professional actors.

### EXAMPLE

### Feasibility Study

Pilot experiments were performed on a group of 10 adult hearing aid users with sensorineural hearing losses ranging from 14 to 57 dB (pure tone average at 500, 1000, 2000 Hz). The subjects had no additional handicapping conditions or evidence of cognitive problems. Their ages ranged from 50 to 80 years of age. All of the subjects had English as a first language. The subjects were recruited from audiological clinics and senior citizen centers in the San Francisco area. All but one of the subjects were experienced hearing aid users (more than 1 year of hearing-aid use). Subject #10 had just been provided with acoustic amplification for the first time.

Each subject was given an IBM T-30 laptop computer to use over a period of three weeks. Each computer was loaded with 15 puzzles. Two of the puzzles were used to explain the procedure and to allow the subject to get used to using the system. The subject then used the remaining puzzles over a 3-week period. The subjects were asked to use the system whenever it was convenient. It was recommended that the subjects use the training system for about ½ hour each day, but they could use it for longer or shorter periods if they wished. At the start of the experiment a video recording of the IEEE sentence test (Hawley, et al. 1999) was administered in noise using an up-down adaptive paradigm to estimate the speech-to-noise ratio at 50% correct sentence identification. The test was administered twice to obtain an estimate of test-retest variability. The IEEE sentence test was administered again at the end of the 3-week training period followed by a structured interview. The video recordings of the IEEE sentences were made by the same speaker who recorded the test items for the cross-sentence puzzle.

The results of the experiment are shown in FIGS. 2 to 4. FIG. 2 shows the decrease in speech-to-noise ratio at which the IEEE sentences were recognized 50% of the time. (Note: ability to understand speech at a poorer speech-to-noise ratio represents improved performance). The subjects are shown in order of the decrease in speech-to-noise ratio that they were able to handle at the end of the training program. The vertical bars show average test-retest standard error for the observed change in speech-to-noise ratio. Subject 10 was the first-time user of acoustic amplification. She showed an improvement of 15.5 dB which was significantly larger than that for any of the experienced hearing aid users.

A statistical analysis was performed on the data of the experienced hearing aid users (Subjects 1 to 9). Subject 10 was omitted from the statistical analysis since the large improvement shown by this subject (15.5 dB) resulted from the joint effect of auditory training and adaptation to acoustic amplification. A repeated measures analysis of variance for the experienced hearing-aid users showed a statistically significant decrease in the speech-to-noise ratio corresponding to 50% intelligibility (F=8.8 (df=1.8), p=0.017). The average improvement was 2.8 dB. A statistical analysis of each subject's performance showed that three subjects (Subjects 1 to 3) did not show a statistically significant change in their speech-to-noise ratio for 50% intelligibility at the end of the training program. The remaining subjects showed a significant decrease in the speech-to-noise ratio, p ranging from <0.1 to <0.0001. For the 6 experienced hearing-aid users showing a significant improvement, the average improvement was 4.1 dB.

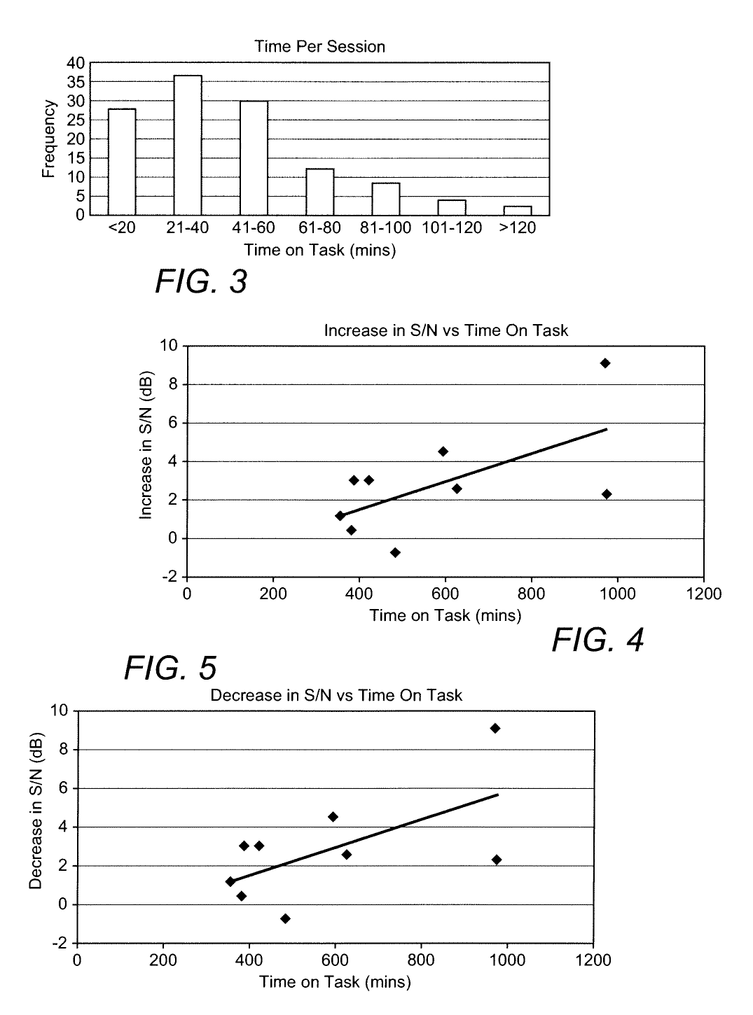

An important feature of a contemplated training program is that it is intended to be entertaining so as to motivate students to use the system over long periods of time. The time spent on the system by each subject for each training session was monitored by the computer. FIG. 3 provides a summary of these data for all of the subjects. Each bar in the diagram corresponds to an interval of time during which the system was used in a single training session. The height of each bar shows the frequency with which the system used for this time interval. For example, the first bar corresponds to a time interval of less than 20 minutes. The height of this bar shows that the system was used 28 times for this time interval in a single training session. The second bar corresponds to a time interval of 21 to 40 minutes. The height of this bar shows that the system was used 37 times for periods of 21 to 40 minutes in a training session.

It is revealing to note that the system was used frequently for periods of time in excess of 40 minutes. The average time spent on the system in a training session was 45 minutes, but there were large differences among subjects. On several occasions, the more highly motivated subjects used the system continuously for periods of up to two hours or more, as shown by the bars to the right of the figure. Not surprisingly, the subjects showing the largest improvements in performance were the ones who spent more time using the system.

FIG. 4 shows the relationship between time-on-task (the total time spent using the system over the 3-week training period) and the change in speech-to-noise ratio corresponding to 50% intelligibility. The data shown are for the 9 experienced hearing-aid users. The correlation between Time on Task and Increase in Speech-to-Noise Ratio was found to be 0.61 (p=0.6, 8 df).

The system also monitored the student's progress during training. Whenever a puzzle was completed, feedback was provided to the student in the form of an index between 0 and 100 which served as a measure of the student's performance. The performance index was based on a weighted average of the speech-to-noise ratio required for solving the puzzle and the average number of attempts at solving the test items. FIG. 5 shows the test scores obtained during the training program for a subject showing a significant change in the speech-to-noise ratio for 50% intelligibility. Positive feedback of this type was found to be very helpful in maintaining motivation.

The final stage of the evaluation consisted of a structured interview with each subject. With one exception, all of the subjects responded positively regarding the value of the system, whether they enjoyed using the system and whether they felt that their ability to understand speech in noise improved as a result of the training program.

The responses to the open ended questions indicated that all but one of the subjects enjoyed using the system and that they felt that their speech reception ability in noise had improved and that they would continue using the system if it was available. The one subject who did not enjoy using the training system did not like the style of humor that was used. This problem can be rectified by including different types of humor for different tastes. Several very useful suggestions were also made for improving the system, such as speeding up the rate of adjustment for matching the difficulty of the training program to each student's level of performance; each test item in a puzzle should be a challenge to the student, either too difficult or too easy. The feasibility study showed significant improvements in speech recognition in noise using the computer-based speech-reception training system.

The average improvement for the 9 experienced hearing-aid users was 2.8 dB. A much greater improvement (15.5 dB) was obtained with a first-time user of acoustic amplification. This result, however, should be considered as no more than a promising case study and that more detailed experiments are needed with new hearing-aid users to determine how much of an improvement can be attributed to the training program and how much is a result of acclimatization to acoustic amplification. It should be noted that the training period was of short duration (3 weeks) and that there was no evidence of a slowing down in the improvement over time for the subjects showing significant improvements in performance. It should also be noted that the feasibility study focused on improving speech reception with both visual and auditory cues. The system can also be used with less sophisticated instrumentation for improving listening skills for audition only.

One feature of contemplated training programs that distinguishes them from traditional auditory training programs is that contemplated training programs are intentionally designed to be entertaining. A training system that is fun to use will not only maintain motivation, it will also be used more intensively and for longer periods of time.

The underlying assumption is that increased use of the training system will result in greater improvements in speech reception ability. The results of the feasibility study support both of these points. All but one of the subjects enjoyed using the system and most of the subjects used the system for longer periods of time per training session than was initially recommended (45 minutes, on average, as opposed to the recommended period of ½ hour per training session). Several of the subjects used the system continuously for periods exceeding an hour at a time and, on average, the subjects who used the system for longer periods of time showed larger improvements in performance. The one subject who did not enjoy using the system did not like the style of humor that was used. This problem can be addressed by developing training materials with different styles of humor to suit different tastes. The entertaining aspect of the training system is expected to be a major plus in marketing the system to prospective users.

An additional strength of a contemplated training system is its adaptive format in which the difficulty of the puzzle items is adjusted automatically to match the student's level of performance. This concept has already been discussed as performance adaptivity. Some of the subjects complained that the rate of adjustment was too slow resulting in some puzzle items being either much too difficult or much too easy. This problem has been addressed in a subsequent study in which more efficient adaptive methods are used to speed up the rate of convergence to each student's level of performance. The use of computer-interactive techniques also allowed for detailed, unobtrusive record keeping as well as on-line computation of relative performance for providing helpful feedback to the student.

### Additional Considerations

These feasibility studies demonstrated that the proposed method of speech-reception training and contemplated systems can improve speech-reception skills in experienced hearing-aid users. In addition, a case study with a first-time user of acoustic amplification showed promise of much larger improvements in speech-reception skills for new hearing-aid users.

It is contemplated that a significant improvement will be obtained over and above that to be expected from acclimatization to acoustic amplification without auditory training. More extensive experiments have been undertaken. Contemplated experimental results not only serve to emphasize the importance of auditory training when hearing aids are first fitted, they also demonstrate that contemplated systems can provide this training in a convenient, efficient and enjoyable way.

Major hearing aid companies are beginning to pay more attention to the importance of providing auditory training for new hearing-aid users and are interested in cost-effective ways of providing this training.

Additional contemplated versions of a contemplated speech-reception training program are currently being implemented and experimentally evaluated:
The style of humor used in the puzzle can be expanded so that users of the system can select a style of humor that appeals to their taste. Although most of the subjects in the feasibility study reported that they enjoyed the humor of the puzzle items, one subject reported the opposite; i.e., she did not like humor that was used. It is important, in order to maintain motivation, that the training program be entertaining and since taste in humor varies widely, several styles of humor will be included in the revised training program. Users of the system will be given the option of choosing a style of humor that they enjoy. For the purpose of the proposed experiments, three categories of humor will be used: 1) low brow humor, such as college humor, 2) popular humor, such as one-liners from popular comedians, and 3) high brow humor, such as witty quotations by scholarly pundits. Additional categories of humor will be added as the product is marketed in order to attract a wider audience.
These feasibility studies were limited to only one speaker, and several speakers, both male and female, are contemplated and have been included in the revised training program so as to train the student to deal with a range of different voices.
In some embodiments, puzzle items were too easy while a few others were far too difficult. Although an efficient adaptive strategy can adjust for a wide range of difficulty among the puzzle items, even the most efficient adaptive strategy cannot sufficiently handle extreme cases, such as when an item is solved immediately on the first trial, or is not solved after many trials even when the background noise is eliminated completely. Puzzle items that are too easy or too difficult have been identified and corrected for by analyzing the detailed log that is maintained of each subject's performance on each puzzle. Two variables have been analyzed, the number of unsuccessful attempts on a given puzzle item and the speech-to-noise ratio when the puzzle item is finally solved. The average value and standard deviation of these two variables has been obtained for each puzzle item. If any of these variables differs from its average value by more than three standard deviations, it has been flagged as an outlier. The puzzle items corresponding to these outliers have then been examined to determine if the item should be eliminated as being either too easy or too difficult.
As pointed out by one of our more critical subjects, the facial expression of the speaker must be appropriate for the utterance. In order to achieve this, new recordings have been made by professional actors and actresses under the direction of a professional video director.
The informational feedback provided to each user on their relative performance has been refined. This information should not only advise subjects how well they are doing, but should also compare their current performance to their previous levels of performance and provide information on their rate of improvement with appropriate supportive comments.
The system may be deployed via a website on the Internet. The initial implementation of the system uses DVDs containing the necessary software and video signals. This requires installing the discs on the user's personal computer. In an internet-based system the software and video signals can be downloaded from the website. This allows for updates, new videos, data collection and other communications with the user to be handled rapidly and conveniently. It is contemplated that the system may be functional on any conventional or newly-developed computer, internet or server-based system.
The system can be implemented in any mobile computer system; e.g., cellular telephone, portable computer, netbook, tablet, wearable computer, smart phone, PDA, Game Boy, Play Station and similar mobile computer systems.
The system can be implemented via audition only. Although hearing aids are widely used for face-to-face communication, there are many communication situations where visual cues are not available, as in a telephone conversation.
The system can be implemented via vision only, as an aid in speechreading training for the profoundly deaf, or in any other application where training in decipherment of purely visual information is required.
The system can be used for a variety of other educational applications, such as foreign language learning, training of customer service professionals (i.e. those who have to learn to understand a variety of speakers), memorization, learning sign language, etc.
A variety of different factors can be adjusted adaptively, not just the background noise—these include the rate of utterance, the degree of dialect, the amount of light, etc.—and different kinds of interference can be adjusted (e.g. single competing voice, white noise, music, etc.). Some specific applications of adapting other variables:
   Hearing impairment resulting from head trauma (a common problem with many injured soldiers) is that speed of comprehension is lowered significantly. In this application of the training system, the rate of speech production would be adjusted adaptively.
   Older people also have more trouble than young adults in understanding rapid speech, or speech that is not articulated clearly. The rate of speech production in the media is increasing, especially in television and radio and commercials, and many older people with normal hearing have difficulty understanding rapid speech.
   Many communication systems have dropouts in which the signal is inaudible for a very short period of time (fraction of a second). The frequency of signal dropouts can be adapted to train people to decipher communications over a poor channel (e.g., cell phone with a weak signal, radio with poor reception, intercom with an intermittent connection, etc.)
It is recommended by many psychologists (e.g. Doraiswamy, 2010) that older people should engage in challenging mental activities to promote both physical and mental well being. Contemplated systems can be used for this application in a variety of different ways including solitaire games, as well as group games, requiring recognition of adaptively adjusted audio-visual speech signals. In these embodiments, the systems are designed to improve cognition skills, and in some instances, speech perception skills.
The system has been implemented using standard video DVDs (see the example below) or other higher-resolution home-entertainment equipment (e.g. Blue-ray), and thus made accessible to those students who do not use personal computers or the internet.

### EXAMPLE

### DVD-Based Systems

Two versions of the DVD-based speech-reception training program are contemplated. One contemplated version (manual version) requires the user to solve each puzzle with pencil and paper in much the same way as a conventional crossword puzzle is solved. Another contemplated version, referred to as the adaptive version, has been also developed. It does not require the user to record his/her responses manually, except for a single index on completion of a puzzle. This index specifies the subject's average level of performance in solving the puzzle and is needed to evaluate progress in the training program. An automated up-down adaptive strategy is used to find the difficulty level at which each puzzle item is solved. An honor system is used in which the subject decides if he/she has solved the puzzle item on each trial. The method is described in greater detail below

A conventional DVD player is the only equipment needed to implement the system; however, any system that can play a DVD is contemplated and can be utilized. Standard or Blu-Ray™ DVD discs are prepared containing video recordings of the puzzle items. For the purpose of evaluating the system, there is one puzzle per disc, but most contemplated systems will have several puzzles per disc. Each disc will be programmed using a standard disc authoring system. The following is a description of the contents of the discs for the two versions of the DVD-based system.

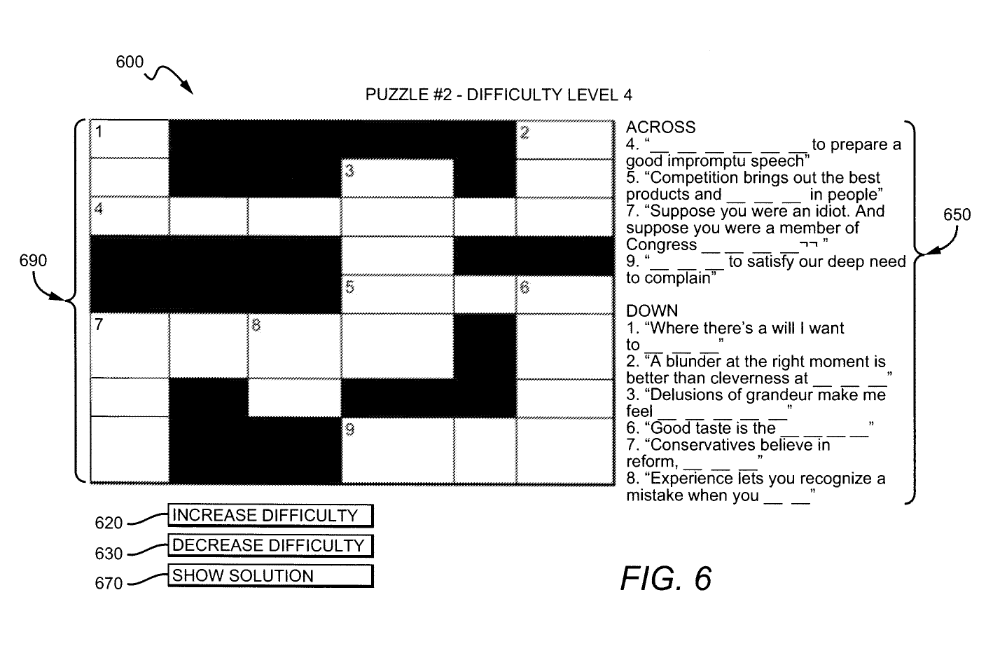

A contemplated set of DVD discs for the manual version will have a set of 7 menus on each disc. The menus will be of the form shown in FIG. 6. The 7 menus will be identical except for one detail, the number after the icon DIFFICULTY LEVEL. This number shows the level of difficulty of the puzzle items for each menu. FIG. 6 shows a complete puzzle 600, including a cross-sentence puzzle 690 with the number 4 listed 610 as the level of difficulty. The level of difficulty can be changed by using the remote control of the DVD player to click on either the INCREASE LEVEL 620 or DECREASE LEVEL 630 icon. For example, by clicking on INCREASE LEVEL 620, a new menu is brought up showing DIFFICULTY LEVEL 5 (not shown). Similarly, by clicking on DECREASE LEVEL 630, a new menu is brought up showing a lower value for DIFFICULTY LEVEL 630. Although the menus are identical (i.e., all of the menus show the same set of clues 650 for a given puzzle) the video recordings for each menu will have a variable (e.g. speech-to-noise ratio, rate of utterance) set to a level which corresponds to the difficulty level. An eighth menu showing the solution to the puzzle is called up by clicking on the icon SHOW SOLUTION 670. The solution for this illustrative puzzle is shown in FIG. 1, which has already been described herein.

The following example illustrates how the manual system is used. The student is given a booklet containing a set of cross-sentence puzzles. The booklet has the same format as a booklet of crossword puzzles except that in order to solve the puzzle, words rather than letters need to be entered in each open box in the puzzle. This is done manually using a pencil (with an eraser nearby to correct wrong entries as the student proceeds to solve the puzzle). The student or user typically begins by selecting a menu of average difficulty; e.g., DIFFICULTY LEVEL 4 (the default condition). The student then clicks on one of the clues shown in the menu. The student might begin by clicking on Clue 4 ACROSS. The video recording corresponding to this clue then appears on the screen. The speech-to-noise ratio for this recording corresponds to an average level of difficulty (i.e., level 4 of 7 possible levels). For this particular puzzle item the video recording would show a speaker producing the sentence “It takes a lot of time to prepare a good impromptu speech”. The clue for this item is “ ______ to prepare a good impromptu speech” which appears as a caption below the speaker's face.

If the student or user is able to recognize the missing words without difficulty, (s)he enters the answer in the booklet showing the puzzle and then clicks on INCREASE LEVEL in order for the next puzzle item to be more difficult. If some, but not all of the missing words are ‘recognized, the student can either attempt to solve the puzzle item again, or try another puzzle item without changing the level of difficulty. If the student cannot recognize the missing words after several attempts, (s)he would then click on DECREASE LEVEL so as to reduce the difficulty of the puzzle. On entering the solution to a puzzle item, the student also enters the difficulty level at which the puzzle item was solved. On completing a puzzle, the student clicks on SHOW SOLUTION in order to view each puzzle item knowing the solution. This will not only serve to reinforce the student's auditory-visual perception of each puzzle item, but will also allow the student to check the accuracy of his/her answers.

The DVD-based speech-reception training system maintains the interactive nature of the computer-based training system, but depends on an honor system for adjusting the level of difficulty to match the student's level of performance. It is also less convenient in that the answers to each puzzle item are entered manually using pencil and paper. Although less convenient than the computer-based system, this procedure has been found to work quite well in a preliminary trial, which is not surprising considering that the use of pencil and paper is widely used in solving crossword puzzles.

The adaptive version of the DVD-based training system has a similar structure. There are 7 menus for each level of difficulty, as used for the Manual version, but with one difference. The two icons showing INCREASE LEVEL and DECREASE LEVEL are replaced with icons showing I HAVE SOLVED THE ITEM and I HAVE NOT SOLVED THE ITEM, respectively. The subject attempts to solve a given puzzle item by clicking on the screen and playing the video recording corresponding to the puzzle item. The subject can play the video recording as often as needed and then decides whether or not s(he) has solved the item and clicks on the appropriate icon. If the subject has not solved the item, s(he) clicks on I HAVE NOT SOLVED THE ITEM. The menu then changes to one corresponding to a less difficult level of difficulty (i.e., the speech-to-noise ratio of the video recording for that menu is increased). The subject then attempts to solve the puzzle item at the easier level of difficulty. The sequence is repeated with the level of difficulty becoming progressively easier until the subject solves the puzzle item and clicks on the icon I HAVE SOLVED THE ITEM. The next menu then shows the correct solution. If the subject judged correctly that s(he) had solved the puzzle item, the subject clicks on an icon indicating this and the next menu will appear with a new test item at a higher level of difficulty; i.e., at a poorer speech-to-noise ratio. If the subject, on seeing the menu with the correct solution, realizes that s(he) had, in fact, not solved the puzzle item, the subject then clicks on an icon indicating this and the next menu then appears with a new test item at an easier level of difficulty; i.e., the associated video recording will be at a higher speech-to-noise ratio.

The procedure continues until all the items on a given puzzle have been solved. The subject then records the level of difficulty at which the last puzzle item was solved. Since the level of difficulty is adjusted adaptively, the final level of difficulty in solving the puzzle is a measure of the subject's level of performance for that puzzle and this information is used in tracking the subject's performance in the training program. Note that in the Manual version, the subject is free to choose the puzzle items in any order; in the Adaptive version, the puzzle items are presented in a predetermined order.

### Additional Experiments

Experiment 1 is designed to evaluate the speech-reception training program with new hearing-aid users. Comparative data with experienced hearing-aid users will also be obtained. A crossover AB/BA experimental design will be used with two groups of new hearing-aid users. Group 1 will use the speech-reception training program for 6 weeks immediately after being fitted with a hearing aid followed by 6 weeks without using the training program. Group 2 will not receive speech-reception training until they have worn their hearing aids for 6 weeks after being fitted. This will allow them time to acclimatize to acoustic amplification after which they will use the speech-reception training program for a 6-week period. A third group of subjects will consist of experienced hearing-aid users. The experienced hearing aid users will begin with 6 weeks without training followed by 6 weeks with training. There will be 24 subjects in each group (see statistical power analysis below).

Subjects who are due to receive 6 weeks of speech-reception training will be given a lap top computer on loan so that they can use the system at home at their own convenience. The subject will be shown how to use the speech-reception training program and will be given two puzzles to practice with under supervision. The audio output of the computer will drive a pair of good quality stereo loudspeakers. The subjects will be instructed to adjust the loudness to a comfortable level and listen with their personal hearing aids as they would in every day listening to television.

The subject will the be given 24 puzzles to work on for the next 6 weeks. The subject will be asked to solve 4 puzzles per week. It is estimated that this will require an average of ½ hour of training each day. Puzzles in three categories of humor will be available for the subjects to choose from. On completing a puzzle, the subject will be asked to rate the humor of each puzzle item on a 5-point scale (e.g., 1=not at all amusing, 5=highly amusing). The ratings will be used to check that an appropriate category of humor has been selected. If low humor ratings are obtained, the humor category will be changed to a more appropriate one. On completion of the experiment, the ratings will be analyzed so as to develop a finer categorization of the humor for the final product.

Arrangements will be made to contact the subjects on a weekly basis, either by telephone or personal visit, to check on progress and resolve any problems that may occur. The computer will be returned at the end of the 6-week training period, the data on the computer will then be downloaded and the system prepared for the next subject. The experimental evaluations will be staggered with 12 subjects using computers at the same time. The estimated time to complete the experiment is 9 months allowing several weeks for slippage and unexpected problems.

All three groups of subjects will be evaluated on four occasions:
1) When hearing aids are first fitted to the new hearing-aid users (Time 1)
2) At the end of the first 6-week period when Group 1 discontinues using the speech-reception training program and Group 2 begins using the training program. Group 3, consisting of experienced hearing-aid users, will also begin using the speech-reception training program at this time (Time 2)
3) At the end of the second 6-week period when Groups 2 and 3 discontinue using the speech-reception training program (Time 3)
4) At the end of a third 6-week period during which none of the subject groups use the speech-reception training program (Time 4).

The subjects will be recruited from physicians’ and audiologists' offices and local speech and hearing centers, senior retirement homes and senior citizens' service centers and organizations, of which there are many in close proximity to SKERI. Dr Simon has a well established network of contacts with these groups and has not had any difficulty obtaining volunteers for her research. Subjects will be evenly divided between male and female with appropriate representation of minority groups. All subjects will be native speakers of English since the training materials are in English.

The subjects will be in the age range between 20 and 70 years of age and will have moderate to severe sensorineural hearing losses typical of the majority of hearing aid users. The new hearing aid users will have been fitted with a hearing aid for the first time. The experienced hearing aid users will have used a hearing aid for at least two years. All subjects will be screened on the basis of pure tone threshold audiometry, speech reception and recognition testing and acoustic-immittance testing. In addition to these audiologic evaluations, measures of auditory processing [the Test of Basic Auditory Capabilities [TBAC], (Watson, 1987)] and cognitive function (Wechsler Adult Intelligence Scale-Revised [WAIS-R], and the Wechsler Memory Scale-Revised [WMS-R], (Wechsler, 1981, 1987)) will also be obtained. These latter tests will screen subjects to ensure intact cognition. Subjects will also demonstrate relatively good physical health and normal daily functioning.

The IEEE sentence test, and the Abbreviated Profile of Hearing Aid Benefit (APHAB) and an interview will be administered at the end of each 6-week period (Times 1 to 4). Table 1 shows the history of training and testing times for each subject group. The interviews will be modeled on the COSI technique (Dillon et al, 1997). Prior to the start of training, the interview will explore each subject's expectations regarding the speech-reception-training program. On completion of a 6-week training period, the interview will focus on the extent to which the training program has met their expectations. The final interview at the end of the experiment will focus on the subject's overall evaluation of the training program and their assessment of its long-term benefits.

TABLE 1
History of Testing, Experiment 1

| | Test Time | 1 | | 2 | | 3 | | 4 |
|---|---|---|---|---|---|---|---|---|
| | Elapsed Time | | 6 weeks | | 12 weeks | | 18 weeks | |
| Group | New User | | Training | | No | | No | |
| 1 | | | | | Training | | Training | |
| Group | New User | | No | | Training | | No | |
| 2 | | | Training | | | | Training | |
| Group | Experienced | | No | | Training | | No | |
| 3 | User | | Training | | | | Training | |

In addition to the measurements obtained at 6-weekly intervals, a detailed log will be kept of the use of the system by each subject on each puzzle. This log will include the speech-to-noise ratios when each puzzle item is solved. These speech-to-noise ratios are expected to be correlated with the speech-to-noise ratios for sentence recognition in noise as obtained with the IEEE sentence test. The data are analyzed using a multi-variate repeated-measures analysis of variance.

The Abbreviated Profile of Hearing Aid Benefit (APHAB) is a 24-item item self-assessment inventory in which the respondents report the amount of trouble they are having with communication or noises in various everyday situations. The APHAB has four subscales: Ease of Communication, Reverberation, Background Noise, and Aversiveness. A multivariate correlation analysis will be performed with the subscales of APHAB and the speech recognition in noise tests.

The data obtained on the Background Noise subscale will be of particular interest. It is anticipated that improvements in speech recognition in noise measured with the IEEE sentence test will show concomitant improvements in the Background Noise subscale and possibly also in the Reverberation subscale.

The data obtained by the computer in monitoring the details of each subject's performance (e.g., speech-to-noise ratio required to solve a puzzle time, number of attempts at solving a puzzle item, time taken for each attempt) will provide a large body of useful information. Note that there are 24 subjects, each of whom will complete 24 puzzles and that there are 6 speakers. If the training program is divided into 4 quarters, it is possible to design a 12×12×12 Latin square with subjects, puzzles and speaker x quarter as the three factors. This design will allow efficient, unbiased estimates of the average performance of each subject during each quarter of the training program, the average difficulty in understanding each speaker, and the average difficulty of each puzzle. Each of these averages can be expressed in terms of several measures, such as the average speech-to-noise required to solve a puzzle, the average number of attempts per puzzle, or the time taken to solve a puzzle. An efficient, objective index of relative performance will be obtained from a weighted average of these measures, the weighting to be determined from a multivariate discriminant analysis of the data.

This performance index will be useful in assessing the progress of each subject during the training program, for analyzing inter-speaker differences (important for both basic research and for developing training strategies for difficult speakers) and for identifying puzzles that are either too easy or too difficult. These outliers will be omitted from the final product.

The ratings of the humor in each puzzle will be analyzed using non-parametric techniques. The median and quartile ratings across subjects will be obtained for each puzzle item. If the 1^{st} and 3^{rd} quartiles do not differ by more than 2 points on the 5-point scale, that item will be defined as being homogenous. A non-homogenous item is one in which a large proportion of the subjects rated the humor one way (e.g., low ratings of 1 or 2) and another large proportion of the subjects rated the humor another way (e.g., high ratings of 4 or 5). The puzzle items will then be sub-divided into categories that are homogenous for different groups of subjects. It is anticipated that these subject groupings will reflect differences such as age, gender, and level of education. The categorization of the puzzle items obtained in this way will be much finer than the 3-categories used in Experiment 1.

The anticipated results for Experiment 1 are:
1) New hearing-aid users will show substantially greater improvements in speech-recognition in noise than experienced hearing-aid users.
2) The improvement in speech recognition demonstrated by new hearing-aid users will include a large component due to acclimatization to acoustic amplification.
3) After taking the effects of acclimatization into account, the improvement in speech recognition will be as large, or larger, than that shown by the experienced hearing-aid users.
4) The Background Noise and possibly also the Reverberation subscales of the APHAB will show a significant correlation with the objective measurements of speech recognition in noise.
5) The analysis of the humor ratings will result in an improved categorization of puzzle items that is much finer than the 3-categories described above. It will also identify categories of humor that are likely to appeal to different groups of potential users depending on factors such as age, gender, and level of education. This improved categorization of the different types of humor will help optimize user acceptability. It will be used in developing the puzzles for Experiment 2 and, after further refinement, in the version for large scale field testing.

Experiment 2 will evaluate two versions of the DVD-based speech-reception training program. The same crossover AB-BA experimental design will be used as in Experiment 1. Two groups of new hearing aid users will participate. One group will begin with the Manual version, the other with the Adaptive version. After 6 weeks, the group using the Manual version will switch to the Adaptive version and the group using the Adaptive version will switch to the Manual version for another 6 weeks of training. The experiment will be terminated after a third 6-week interval without training. New hearing aid users will participate in this experiment since they are expected to show large training effects and will thus provide a sensitive test of any differences in the effectiveness of the two versions of the DVD-based training system. As in Experiment 1, there will be 24 subjects in each group, the statistical power analysis being the same for the two experiments.

Each of the subjects will be given a DVD player with a set of discs containing the puzzles to be worked on. On receiving the DVD player, the subject will be shown how to use the training program and will be given two puzzles to practice with under supervision. As in Experiment 1, the subject will be asked to solve 4 puzzles per week. Arrangements will be made to contact the subjects every week, either by telephone or personal visit, to check on progress and resolve any problems that may occur. The DVD player will need to be returned at the termination of training. The puzzle booklets used with the Manual version and the indices of performance recorded by the subjects using the Adaptive version will be picked up at weekly intervals. This procedure will allow for data analysis to be performed on an ongoing basis and will also allow for the early detection of any problems during training.

As in the first experiment, the subjects will be evaluated on four occasions. 1) At the start of the training program, 2) after 6 weeks of training with one version of training system, 3) after 6 weeks of training with the second version of the system, and 4) 6 weeks after termination of training. The same test battery as in Experiment 1 will be used. On completion of training (week 12), the subjects will be given a questionnaire focusing on a comparative assessments of the Manual and Adaptive versions from the subjects' perspective. The experiment will be staggered with half of the subjects in each group receiving training at the same time. The estimated time to complete the experiment is 9 months allowing several weeks for slippage and unexpected problems.

The data analysis will be analogous to that of Experiment 1. A multi-variate repeated-measures analysis of variance will be performed on data obtained with the IEEE test and a multivariate correlation analysis will be performed with the subscales of APHAB and the speech recognition in noise tests.

The anticipated results for Experiment 2 are:

1) Both versions of the DVD-based system will show significant improvements in speech recognition in noise.
2) The two versions of the DVD-based system are expected to show similar improvements in speech recognition in noise, but user preference will strongly favor one of the two versions.
3) As in Experiment 1, a small reduction in speech recognition ability is anticipated after 6 weeks without training.

Experiment 3 is designed to evaluate the computer-based speech-reception training program for audition only. The scope of this experiment is much narrower than the previous two experiments. Only one group of 24 subjects will be tested over a 12 week period in order to obtain data on the improvement in speech recognition in noise for a computer-based speech-reception training program using audition only. The same computer-based will be used as in Experiment 1, but with the video signal suppressed.

The subjects will be evaluated on three occasions: 1) At the start of the training program, 2) after 6 weeks of training, and 3) 6 weeks after termination of training. The anticipated duration of this experiment is 6 months. As in the previous experiments, a multi-variate repeated-measures analysis of variance will be used to analyze the data.

The anticipated results for Experiment 3 are:

1) Speech-reception training using audition only will show significant improvements in auditory speech recognition in noise
2) Auditory-visual speech recognition in noise will also improve, but by a smaller amount than that obtained with auditory-visual speech-reception training (comparative data obtained from Experiments 1 and 2)

### Statistical Power Analysis

The least sensitive comparison of interest is that between two groups of subjects for two experimental conditions. For example, in Experiment 1 a contrast of interest is the difference in speech-to-noise ratio between Week 0 and Week 6 for the group of subjects receiving speech-reception training compared to the difference between Weeks 0 and 6 for the group of subjects not receiving speech-reception training. This comparison involves a linear combination of 4 measurements (2 for each group) so that the variance of the data for this comparison is 4 times the variance of each measurement. The repeated measures analysis of variance in the feasibility study showed a between-subject variance of 1.4 dB² (excluding the outlier). For a linear combination of 4 group means the variance will be (4×1.4/n) dB² where n is the number of subjects within each subject group. Assuming a normal distribution, a minimum of 22 subjects is needed in order to detect a difference as small as 1 dB with an error probability of 0.05. Increasing the number of subjects in a group to 24 will allow for tests of more than sufficient sensitivity for the least sensitive comparisons of interest.

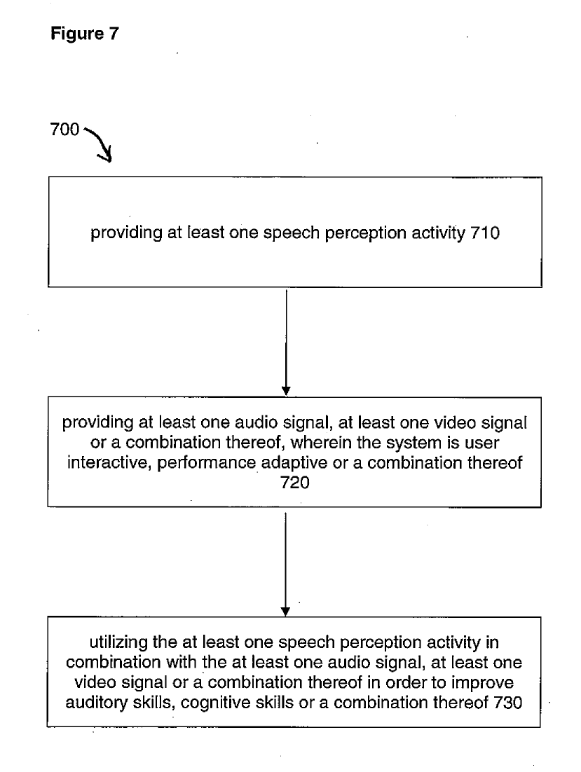

Methods 700 of training and improving auditory skills, cognitive skills or a combination thereof, includes: providing at least one speech perception activity 710, providing at least one audio signal, at least one video signal or a combination thereof 720, wherein the system is user interactive, performance adaptive or a combination thereof; and utilizing 730 the at least one speech perception activity in combination with the at least one audio signal, at least one video signal or a combination thereof in order to improve auditory skills, cognitive skills or a combination thereof, as shown in FIG. 7.

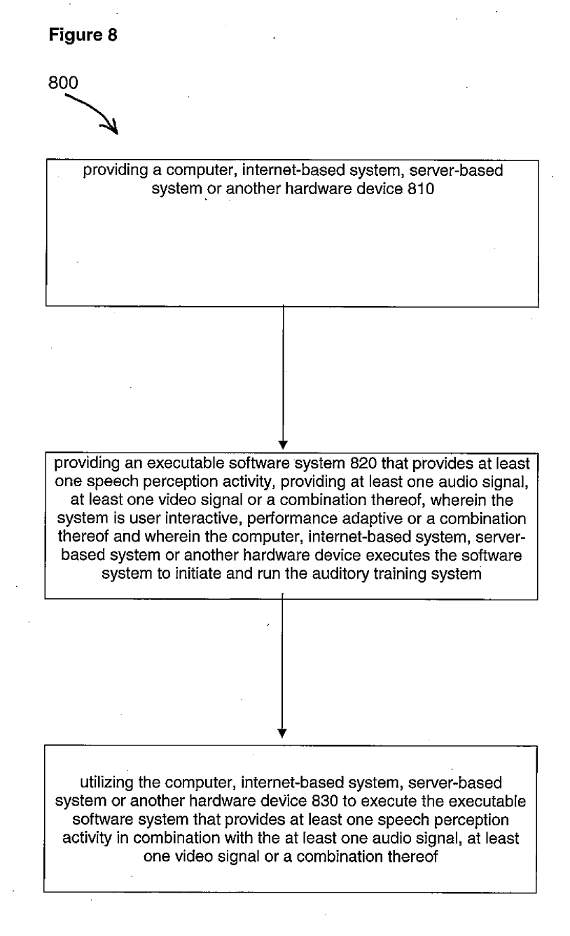

Methods of training and improving auditory skills, cognitive skills or a combination thereof 800 includes providing a computer, internet-based system, server-based system or another hardware device 810, providing an executable software system 820 that provides at least one speech perception activity, providing at least one audio signal, at least one video signal or a combination thereof, wherein the system is user interactive, performance adaptive or a combination thereof and wherein the computer, internet-based system, server-based system or another hardware device executes the software system to initiate and run the auditory training system; and utilizing the computer, internet-based system, server-based system or another hardware device 830 to execute the executable software system that provides at least one speech perception activity in combination with the at least one audio signal, at least one video signal or a combination thereof, as shown in FIG. 8.

### A Contemplated System User Manual

### Introduction

It should be noted that this contemplated system user manual is directed to one version of the contemplated system, but as other contemplated embodiments are developed, such as 64-bit, iPad, other tablets, hand held devices, and the like, additional user manuals or amended user manuals will be and/or are drafted. For example, another contemplated embodiment provides that contemplated systems are distributed via internet download and the content is stored on and provided from central or regionally located servers. Another embodiment provides that contemplated systems are fully internet browser-based and therefore, no downloading is needed by the user. Each of these contemplated embodiments would be fully described in an overall user manual or have individual user manuals directed to their individual capabilities.

Enhanced Communication with ReadMyQuips™

Perhaps the most common complaint among people with hearing loss is that speech is difficult to understand in a noisy environment. Often, because of this difficulty, people isolate themselves (and their significant others) from many social situations that they previously enjoyed. ReadMyQuips™ is an innovative training program specially designed to help you face these challenges in a fun and creative way. Clinical studies indicate that with dedicated practice using ReadMyQuips™, many people can significantly improve their speech perception capabilities, thus gaining the confidence they need to tackle everyday, difficult listening situations.

Face-to-face communication makes use of a skill known as lip reading. Actually, the more correct term for this skill is speech reading, because although it is true that the lips convey valuable information, they are not the only source of clues to comprehension. When we speech read, we also get information from facial expressions, body language, and the situational context of the conversation.

There are two basic approaches to improving speech reading. One approach involves focusing on the individual sounds of speech and the associated facial patterns. This is known as the Analytic approach. Unfortunately, parts of speech look and sound different when they are used in natural conversation as opposed to the way they look and sound when produced individually. Also, by focusing too intensely on one sound, it is likely that another sound will be missed. This makes the Analytic approach problematic.

The other approach—and the one we recommend—is to try to understand the message that is being communicated and then let your brain put the pieces together. This method is known as the Synthetic or Global approach, since the focus is on understanding the message as a whole—the big picture—and not on deciphering individual sounds. Besides being more effective, this technique is also generally less stressful because it involves intuition and imagination.

One of the most remarkable aspects of human communication is that everybody speechreads (lipreads) to some extent, even those with perfectly normal hearing. It is an intuitive process, sort of like learning to run. And, as with running, training can help improve your skills significantly. The key to the global approach to speechreading is to get lots of practice.

And practice is what we hope to inspire you to do with ReadMyQuips™. A unique aspect of this training program is that it is entertaining. Your task is to solve a puzzle similar to a crossword puzzle except that you have to speechread the answer to each clue. While you are having fun solving the puzzle, you are also exercising and improving your speechreading skills.

ReadMyQuips™ is also unique in that it is adaptive. As you work through the puzzles, the difficulty level changes to match your growing proficiency. As a result, each puzzle continues to be challenging but solvable, even as your skills improve.

The first few puzzles may be relatively easy for you to comprehend, but as you go on the noise level will increase and you will be forced to depend upon speechreading cues more and more. This is as it should be. In real-life, varying levels of background noise are a ubiquitous presence, and the information gained through speechreading becomes more and more important as the noise increases.

Each time you play one of the video clips, fill in as many words of the sentence as you can, guessing when you are not exactly sure (the program will inform you whether or not you're correct). As in real-life, the more of a sentence you guess correctly, the easier (generally) the rest of the sentence should be for you. This is because the more you know the context of a sentence—any type of context (e.g., the situation, topic, speaker, etc.)—the more likely it is that you will comprehend the rest of the utterance. Remember: your goal is to comprehend the sentence, and you should use whatever cues you can to accomplish this purpose. You will find that the blank response boxes (where you type your answer) are usually framed by preceding and/or following visible words; these are part of the sentence and thus are also cues, much as you would find in real life (don't you often get just part of a sentence, but not all of it?). Therefore, before you click on the video image to play the sentence, first read these framing words and then try to fill in the remaining words in the response boxes.

If there is one key element to speechreading, it is that you must see the lips in order to do it. Now this may sound like a facetious statement, but it is not. Many people with hearing loss seem to focus their eyes everywhere but where they should: The fact of the matter is that we have often been conditioned to look our conversational partners “right in the eye.” Now that's well and good in most situations, but it's not conducive to maximizing the information you can get from a person's lip movements. So, in going through these lessons, lower your eyes a bit; some people focus somewhere around the nose and some directly on the lips. As it happens, your ability to perceive the tiny and rapid movements of the moving lips is better at the center point of your eye focus than at positions even slightly off. And even when you look directly at the lips, you should still be able to appreciate the broader facial expressions. After some practice, you'll soon determine which focus point is best for you.

ReadMyQuips™ also allows you to display the speaker's face in full-screen mode. Think of this as comparable to the real-life situation of first being some distance from a speaker (the usual screen display) and then being only a few feet away (for more personal conversations).

Seeing the lips as best you can implies that your corrected vision (if you wear eyeglasses) is accurate and up to date. We have often seen people with uncorrected or improperly corrected vision struggle to speechread when they could barely see a person's lips six or eight feet away. So before you begin ReadMyQuips, be sure that your eyeglass prescription is up to date; you're not going to do very well if the lip movements are simply a blur.

In real-life, it sometimes takes a bit of assertiveness in order for you to see a person's lips as well as possible. For example, the person who is talking to you while eating, smiling, or otherwise distorting their lips during the conversation is going to be much harder to understand. It's up to you to inform such people what they have to do in order for you to understand them (and presumably, they do want to be understood or else why talk to you at all?). As for the surgeons in the operating room taking out your appendix: forget it! Just be sure they know you're not going to be able to understand them very well when they have their mouth covered with a mask (though you should depend upon your hearing as much as you can in this situation).

We emphasize that ReadMyQuips™ is not a typical speechreading program, but that it targets background noise as a primary training factor. This is how it is in real life. We expect that most people using this program wear hearing aids or cochlear implants. These are marvelous devices and there is no question that they help most people with hearing loss hear better. But though they are undoubtedly necessary, they are often insufficient, at least in noisy places. This is where vision and speech reading come in. It turns out that precisely those speech sounds that are the most difficult to hear (like /f/and/th/) are the ones easiest to see. The reverse is true as well; those sounds that can easily be confused visually (try to see the difference between a/p/, /b/, and /m/—there is none!) can be differentiated through hearing. So with hearing and vision working together, the person with a hearing loss has a much better chance of comprehending speech than with either alone.

What this program is designed to do is to give you practice in comprehending speech under increasingly noisy conditions. Your mission (and you've decided to undertake it!) is to tolerate the loudest noise you can while still being able to completely understand an utterance. Not all of the speakers are equally intelligible; some are easier to understand than others. This, too, is what is normally found in real life. Some people, like ventriloquists, hardly move their lips at all. Others over-exaggerate each sound in trying to be “helpful” to you. Neither is very desirable, but both types are commonly found. You will not find these extremes in any of our four speakers, but you will (and likely already have) in real-life.

The ultimate goal of any type of any audio/visual training program is to enhance your overall communication skills. Sometimes, in spite of your best use of the visual and auditory cues available to you, you still don't understand what someone is saying. You can simply say “what?” but then the person is likely to repeat the sentence exactly as they said if before. Sometimes this is enough (though it is better for you to ask the person “can you say that again?”). When communication breaks down, it is often helpful if you can inform the person you're talking to what he/she has to do to make it easier for you to understand. That is, if they're talking too quickly or too softly, ask the person to “slow down a bit” or to “say that again just a little louder.” Think of this as grandma's scolding you and telling you to “speak more clearly” (which really means for you to pronounce your words a bit more precisely). This is called “clear speech” (repeating, rephrasing, slowing down, more precise pronunciation). Years ago, at MIT, researchers found that clear speech was a very effective way of improving speech perception, compared to the way a person normally spoke. Fortunately, you won't have to scold any of the speakers in this program!

Don't get discouraged as you go through the exercises in the ReadMyQuips™ program, and don't give up. You should have difficulty; if you didn't, you wouldn't be undertaking the training in the first place. It is necessary for you to keep at it, keep practicing, trying to tolerate the loudest background sounds you can while still understanding the utterances. We suggest that you devote about 30 minutes for each lesson four or five times a week. You don't have to finish a lesson in one day; it will be there waiting for you when you're ready to continue. By the time you finish the last puzzle, you should be able to tolerate louder levels of noise while still understanding the sentence. And this improvement will carry over to the noisy situations you confront in real-life.

### Installation

### For Microsoft Windows XP or Vista

To install ReadMyQuips™, insert this DVD in your computer's DVD drive. Depending on your system configuration, the setup program may start automatically, or you may be presented with the option to start it. If not:
1. Select My Computer (Windows XP) or Computer (Windows Vista) from the Windows Start Menu.
2. Double-click on the drive icon labeled RMQ or ReadMyQuips™.
3. Double-click on the icon labeled Setup or Setup.exe.

Once started, the setup program will guide you through the installation process. You will be prompted for an install location, and given the option to install the software alone, or together with all video.

The full installation (softwares-video) requires approximately 4 GB of space on your hard-drive. However, if you do not install the video, you will need to insert the DVD every time you wish to use the program. In addition, on some systems, playing the video from DVD may result in intermittent skipping and stuttering. For best results, we recommend installing the video onto your computer.

Note: You must have administrator privileges on your computer to install this software. Also, you may encounter a number of security warnings, either from Windows itself or from your anti-virus software. Click Run, Open, or Allow when prompted.

Once you have installed the software, you can start the program by double-clicking on its icon on the desktop, or by selecting it from the Start Menu.

### For Mac OS-X

Important Note: Support for ReadMyQuips™ under Mac OS/X is still in its preliminary phase. We are making every effort to improve the functionality of the program in OS/X, but you should expect some issues, particularly regarding video playback.

To install ReadMyQuips™, insert this DVD in your computer's DVD drive, double-click on the RMQ icon on your desktop. Before installing, please double-click on the file called LICENSE.PDF to read the License Agreement. By installing this software you are accepting this agreement. Now, open the OSX folder and drag the ReadMyQuips™ application to your Applications folder (or wherever you wish on your hard drive). If you like, you can also install the video by dragging the RMQMedia folder somewhere on your hard drive.

The full installation (software+video) requires approximately 4 GB of space on your hard-drive. However, if you do not install the video, you will need to insert the DVD every time you wish to use the program. In addition, on some systems, playing the video from DVD may result in intermittent skipping and stuttering of the video. For best results, we recommend installing the video onto your computer.

Once you have installed the software you can start the program by double-clicking on its icon in your Applications folder. You can also add ReadMyQuips™ to your dock by dragging it there from the Applications folder.

The first time you run ReadMyQuips™ you will have to tell the system where the video is located (either on the DVD or on your hard drive). You will be prompted to do this at program startup. You can also do it later by taking the following steps:
1. Select Advanced Configuration from the Settings menu.
2. Click on the Content tab.
3. Click Add.
4. Navigate to the RMQMedia folder on the DVD or on your hard drive (if installed) and click Select.

5. Click OK.

Important Note: In order to use the update feature under OSX, you may have to give yourself write permission to the ReadMyQuips™ bundle by following the following steps after copying ReadMyQuips™ to your hard disk:
1. Right-click (or Control-click) on the ReadMyQuips™ application in the Finder, and select Show Package Contents.
2. Right-click (or Control-click) on the Contents folder, and select Get Info.
3. Unlock the panel if necessary by clicking on the lock icon in the lower right corner and entering an administrator password.
4. In the Sharing and Permissions section of the panel, find your user name and set the Privilege to “Read & Write”
5. Click the tools icon (which looks like a small gear) at the bottom of the panel, and select Apply to enclosed items.

6. Click OK.

You should now be able to update ReadMyQuips™ normally.

### Uninstalling

You can uninstall ReadMyQuips™ at any time. Under Windows, just select the Uninstall option from the ReadMyQuips™ folder on the Start Menu. Under OS-X, just drag the ReadMyQuips™ application to the trash. Note that if you install the video on your computer, you will have to uninstall it separately.

Guess the quips . . . . . . as you learn to read lips!

ReadMyQuips™ consists of a set of puzzles. Each is like a crossword puzzle, except that each blank box represents a word rather than a letter. The words go together across or down to form witty or wise quotations (quips) which you must guess. The clues are video recordings of the quips spoken in a noisy environment.

To work on a quip, double-click on one of the boxes which comprise it. A new window will open in which you can play the video and try to guess the missing words.

Guess the missing words.

Click anywhere on the image to play the video. Type your guesses into the blank boxes at the bottom of the screen, and press ENTER or the SPACE BAR to move to the next box. If you are right, the box will turn gray, and you won't be able to type in it any more. Otherwise, the text you type will show in red. To reveal the word in any box, right click in the box.

To expand the image to fill the screen, click Fullscreen; to return again, click Exit Fullscreen

Click Make Easier or Make Harder to change the level of the speech relative to the noise.

Click Return to Puzzle if you want to try another item. If you guess all the words correctly, you will return to the puzzle automatically.

### Levels and Difficulty

As you work on a puzzle, the difficulty (i.e., the loudness of the background noise relative to the speech) will automatically adapt to your progress. The quips will get harder to understand as you guess them correctly, and easier as you miss them.

You will also be able to adjust the difficulty of an individual quip while you are viewing the video.

To set the overall audio levels, use the volume controls on your computer.

### Managing Puzzles

ReadMyQuips™ comes with several puzzles built-in. You can either work on one puzzle until you've finished, or move back and forth between puzzles by clicking on the Next Puzzle and Previous Puzzle buttons at the bottom of the screen.

If a puzzle is too big to fit in the window, you can use the scroll bars on the bottom and right sides of the puzzle to view the hidden portion.

### Who's Speaking?

In some puzzles, each quip has been recorded by more than one speaker. When you open a quip, a speaker will be chosen at random from those available.

You can limit the available speakers for a puzzle at any time by selecting Choose Speakers from the Settings menu.

Note that this option will not be enabled if there is no choice of speakers for the current puzzle.

### Display Options

You can make the text of a puzzle bigger or smaller by selecting Zoom In or Zoom Out from the Settings menu. If a puzzle is too big to fit in the window, you can use the scroll bars on the bottom and right sides of the puzzle to view the hidden portion.

You can also control whether video recordings play on the full screen or in a window by selecting Play video using full screen from the Settings menu.

### Managing Sessions

When you quit the program, your progress and settings will be saved automatically so you can pick up where you left off.

If you'd like to save your current progress and start over, you can choose Save Session from the File menu at the top o the screen. You will be prompted for a location in which to save the current session information.

Then choose New Session to clear all your answers and start over, or Open Session to choose a saved session from your disk and restore it.

### Feedback and Updates

Please help us make ReadMyQuips™ better by reporting any software errors you encounter, and telling us what you think. Just choose Send Feedback from the Help menu.

You can also automatically download and install the latest updates to ReadMyQuips™ by choosing Update from the Help menu*.

Note that you must have an active internet connection. Also, if you use a firewall, you may have to configure it to allow ReadMyQuips™ to access the internet.

* Under OSX, if you receive a “Permission Denied” error when trying to update, please see the Installation Instructions for a solution.

### Advanced Configuration

Many aspects of ReadMyQuips™ are configurable. To view these options, select Advanced Configuration from the Settings menu. You will then have access to an advanced dialog. You can restore all settings to their initial values at any time by selecting Restore Defaults from the Settings menu.

Note: You should use caution when modifying most of the settings below. If you have doubts or questions, leave the settings at their default values.

The advanced configuration dialog is organized into four tabs.

### Display

### Font Size

The font size (in points) is for all puzzles. Take care when setting this that it does not make any puzzles larger than the screen. Using a 1024×768 monitor, a font size of 11 seems to work well for all the puzzles provided with the software.

### Player Font Adjustment

An adjustment to the font size which can be used to make the font larger in the player window (the window in which video is displayed and you can guess answers). The font in this window will be equal to “Font Size+Player Font Adjustment”

### Use Wallpaper

Check this box to display a picture as background for each puzzle. The program will look in the media folder for each puzzle for a file called [puzzlename].JPG. If such a file does not exist, then the default wallpaper file specified below will be displayed.

### Default Wallpaper

The default wallpaper file to be displayed when wallpaper is enabled and no wallpaper file specific to the current puzzle can be found.

### Background Color

The color of the puzzle background when no wallpaper is selected.

### Show Video

Check this box to enable the video when solving clues. If unchecked, only the audio will be played.

### Default Video File Extension

The default extension (eg MP4 or AVI) of the video files used by ReadMyQuips™. Note that most puzzles (including those provided with ReadMyQuips™) specify their own video file type automatically, so this parameter is generally ignored.

### Always Use This Type

Check this box to override any video file type information included with puzzles. ReadMyQuips™ will only look for video files with the “Default Video File Extension” specified above.

### Use Low Resolution Video if Available

Check this box to cause ReadMyQuips™ to play a lower resolution version of the video. Useful if you are experiencing intermittent problems with video playback.

### Use Lightweight Video Rendering

Use this box to control the way in which ReadMyQuips™ renders video. Can be useful if you are having video rendering issues.

Levels

### Use Noise.

Check this box to enable the use of background noise.

### Noise File.

Selects the “way” file containing the background noise. The software ships with this file set to “NST NOISE.WAV” which contains actual cafeteria noise.

### Test Speech.

Selects the file containing the speech to be played when testing levels. Can be a MPG video file or a WAV file, but only the audio will be played. Initially set to “TEST SPEECH.WAV”

### Signal Level.

Sets the calibrated signal level relative to system maximum. This determines the minimum signal-to-noise level. The raw signal level (i.e the system gain in dB relative to system maximum) is equal to the calibrated signal level minus the calibration offset for that file, plus the reference offset (see below).

### S/N Level

Sets the current signal-to-noise ratio. If adaptation is enabled, this will be modified as you works through the puzzles, according to the adaptive rules defined below.

### Test Levels

Click this button to play the specified noise file and test speech file at the specified levels.

### Keep Signal Level Constant

Check this box to keep the signal level constant. When unchecked, the signal level set above will be maintained unless it is necessary to reduce it in order to achieve a target SIN ratio.

### Use Calibration File

Check this box to use audio level calibration information in setting levels. If this box in unchecked, then actual signal level and SIN may vary depending on the power of the various audio files.

### Calibration File

Specify the audio level calibration information file to use. By default, the software uses “CALIBRATION.TXT” which contains pre-generated calibration information for all media in the ReadMyQuips™ video pack, as well as any calibration files packaged with additional content.

### Reference Offset

A constant used to ensure that a maximum calibrated signal level of 0dB will not exceed the system maximum gain. See above for more information.

### Show S/N Control in Player

Check this box to allow you to manually change the S/N ratio when solving an item.

### Adaptation

### Enable Adaptation

Check this box to enable adaptive modification of the S/N level.

### Step Size

The amount by which the speech-to-noise ratio will be increased when you don't guess all the words of an item correctly, or decreased when you get them all on the first try.

### % Correct to Hold S/N Constant

By default, the noise level will be decreased every time you fail to identify all the words in a given item. This parameter lets you specify a minimum percent correct above which the S/N will remain unchanged. For example, if you set this to 50%, and you identify 6 out of 10 words, the S/N will remain unchanged on the following attempt.

### Number of Plays Allowed for First Attempt

Determines the number of times you may play the video before the first attempt on an item is considered complete (ie before the noise level is changed according to the adaptive rules). Applies only to the first attempt after an item is opened for solving.

### Number of Plays Allowed Per Attempt

Determines the number of times you may play the video before an attempt on an item is considered complete (i.e before the noise level is changed according to the adaptive rules). Applies to all attempts after the first.

S/N Offset for New Item

When you open an item for the first time (an item never before attempted), the S/N is computed based on the S/N for all other open items in the puzzle. Use this offset to raise or lower the computed starting S/N by a fixed amount.

### Use Smart Averaging

When disabled, the S/N for a new attempt is determined by the S/N at which you completed the last item. When enabled, the starting S/N is computed by a more complex algorithm which should more accurately track your level of proficiency.

### Number of Attempts to Average

When using smart averaging, only the most recently solved items are counted toward the average. This parameter specifies how many attempts to use.

### Adjust for Context

When enabled, takes the amount of context available (ie the proportion of visible words to hidden words) into account, by adjusting the effective S/N of a presentation according to the context level.

### Context Baseline

The context level which is considered normal, expressed as a proportion of visible words to hidden words.

### Context Delta

The difference in context level which will establish a 1 dB change in the effective S/N of a presentation. For example, if the context baseline is 50% and there are 6 out of 10 words visible, and the context delta is 10, then the presentation will have an effective S/N that is 1 dB higher than the actual S/N—that is, it will be treated as though it had been presented at a higher S/N because it is relatively easier than the norm.

### Content

When you install ReadMyQuips™ you have the option of installing the video to your hard drive, or leaving it on the DVD. By default, ReadMyQuips™ searches all mounted DVD drives for video, in alphabetical order. If your video is located elsewhere (on a network drive, for example, or an external hard drive), you can inform ReadMyQuips of the location of the video using this dialog.

### Current Media Locations

A list of places ReadMyQuips™ should look for video. Locations will be searched in the order in which they appear in the list. Use Move Up and Move Down to change the search order. Use Add to navigate to a folder containing video and add it to the list

### Search Automatically for New Video

When this box is checked (the default), ReadMyQuips™ will search automatically for video on all mounted DVD drives and in all installed video folders. If you uncheck this box, only the folders you explicitly specify in the list will be searched.

### Troubleshooting

### Video Playback Issues

If you experience problems with video playback (for example, skipping or freezing of the picture, sound and picture out of sync, etc.), one of the following solutions may remedy the problem.

Install Video to your Hard Drive

If you have not already done so, try installing the video to your hard drive rather than trying to play it from DVD. To do so, follow the installation instructions at the beginning of this manual.

Adjust Power Settings on your Computer

Many computers, especially laptops, automatically limit the performance of their processors to conserve power when running on batteries. This may cause problems with playback of the video included with ReadMyQuips™. You should check to make sure your computer's power management software is set to maximize performance. For Macintosh computers, this option is available in the Energy Saver section of System Preferences. For most windows computers, a similar option is usually available on the control panel, although some computers may have their own, proprietary power management software. For more information, consult the documentation that came with your computer

### Try Low-Resolution Video

ReadMyQuips™ includes video encoded in both high and low resolution formats. The low resolution format may work better on some older computers. To use the lowers format, select Advanced Configuration from the Settings menu, switch to the Display tab, and click on the checkbox labeled Use Low-Resolution Video If Available.

You can also try to use an additional format which is slightly better quality than the included low-resolution video. On the Display tab of the Advanced Configuration dialog, verify that the Video File Extension is set to “mq800.mpg”, and then click on the checkbox labeled Always use this format to select that format for all puzzles.

### Mac OS/X Issues

If you experience problems running ReadMyQuips™ on a Macintosh computer, please try some of the following fixes.

### Use the Correct Version of Java

ReadMyQuips™ requires the Java Virtual Machine 5.0. This is included with OS/X 10.5 (Leopard). To verify that it is present on your system, open Java Preferences (from the Finder choose Go and then Utilities, and then double click on Java Preferences), and make sure J2SE 5.0 32-bit is listed in the Java Applications section of the General tab. If you are running Leopard and this version of Java is not present, you can download and install the latest Java Updates directly from Apple at http://support.apple.com/downloads/Java for Mac OS X 10 5 Update 4.

### Run in 32-Bit Mode

More recent versions of OS/X 10.5 will attempt to run applications in 64-bit mode on compatible computers. However, ReadMyQuips™ will only function when run in 32-bit mode. To verify that this is configured properly, right-click (control-click) on the ReadMyQuips™ application in the Finder, and select Get Info (or highlight the ReadMyQuips™ application and choose Get Info from the File menu). Make sure the checkbox labeled “Open in 32-bit Mode” is selected.

### Snow-Leopard Issues

Mac OS/X 10.6 (Snow Leopard) does not include the correct version of Java to run ReadMyQuips™. However, it is possible to download the correct version and install it manually. Good, step-by-step instructions for this process are available at http://chxor.chxo.com/post/183013153/installing-lava-1-5-on-snow-leopard.

### Getting Further Assistance

If you experience problems with ReadMyQuips™ that are not resolved by any of the suggestions above, you can request assistance directly from within the program by, selecting Send Feedback from the Help menu. Describe the problem you are having in the box provided, and be sure to provide your e-mail address. Someone from technical support will contact you as soon as possible.

### LITERATURE CITED

Blarney, P. J. and Alcantara, J. I. (1994). Research in auditory training. J Acad. Rehabilitative Audiology, 27(suppl.) 161-192.
Boothroyd, A., Hanin, L. and Waltzman, S. (1987). Development of speech perception skills in cochlear implantees. Proc. 10^{th} Annual Conf. Rehabilitative Society of North America (RESNA), 428-430.
Cox, R M and Alexander, G C. “The Abbreviated Profile of Hearing Aid Benefit (APHAB)”. Ear and Hearing, 16, 176-186 (1995).
CHABA, Working Group on Communication Aids (1991). Speech perception aids for hearing-impaired people: Current status and needed research. J. Acoust. Soc. Am., 90(2), 637-685, 1991.
Chisolm T H, Abrams H B, McArdle R. (2004) Short- and long-term outcomes of adult audiological rehabilitation. Ear Hear.;25(5):464-77.
Clark, G. (2003). Cochlear implants: Fundamentals and applications. New York: Springer Verlag, Inc.
De Filiippo, C. L. (1988). Tracking for speech reading training. Volta Review, 90, 215-237.
DeFilippo, C. and scott, B. (1978). A method for training and evaluating the reception of ongoing speech. J. Acoust. Soc. Am., 63, 1186-1192.
Dillon H, James A, Ginis J. Client Oriented Scale of Improvement (COSI) and its relationship to several other measures of benefit and satisfaction provided by hearing aids. J Am Acad Audiol. 1997 February; 8(1):27-43.
Doraiswamy, Murali (2010). AARP Magazine, March-April 2010)
Garstecki, D. (1982). Rehabilitation of hearing handicapped elderly adults, Ear & Hear., 3(3), 167-172.
Gatehouse, S. (1993). Role of perceptual acclimatization in the selection of frequency responses for hearing aids. J. Amer. Acad. Audiol. 4(5), 296-306.
Ghent, R. M., Bray, V. H. and Johns, M. (2001) An aural rehabilitation tool for instant-fit hearing aids, American Academy of Audiology, Poster, April 2001.
Hawkins D B. (2005).Effectiveness of counseling-based adult group aural rehabilitation programs: a systematic review of the evidence. J Am Acad Audiol. 16(7):485-93.
Hawley, M. L., Litovsky, R. Y. & Colburn, H. S. (1999) J. Acoust. Soc. Am. 105, 3436-3448.
Hudgins, C. V. (1954) Auditory training: Its possibilities and Limitations. Keynote address, 63^{rd} Meeting of the A.G. Bell Association for the Deaf, Reprint #652, The Volta Bureau, Washington, D.C. Reprinted in: Summary Report of the Group Hearing Aid Project, Washington, D.C.: National Research Council
Humes L E, Burk M H, Strauser L E, Kinney D L. (2009) Development and efficacy of a frequent-word auditory training protocol for older adults with impaired hearing. J Speech Lang Hear Res. 2008 June; 51(3):759-71.
Jeffers, J. and Barley, M. (1971) Speechreading (lipreading). Springfield, Ill.: Charles C. Thomas.
Kates, J. (1994). Speech enhancement based on a sinusoidal model. J. Speech Hear. Res., 37(2), 449-464.
Kochkin, S. (1999) MarkeTrak V: ‘Baby Boomers’ spur growth in potential market, but penetration rate declines. Hearing Journal, 52(1), 33-48.
Kochkin, S. (2000) MarkeTrak V: Consumer satisfaction revisited. Hearing Journal, 53(1), 38-55
Kotchkin, S. (2001). Market Trak, Hearing Review, December 2001.
Kochkin S. 2009 BHSM kit. [Online]. 2009 May [Cited June 2009 1]; [1 screen]. Available from: URL:http://www.betterhearing.org/professionals/turnkey09.cfm
LaPlante, M. P., Hendershot, G. E. and Moss, A. J. (1992). Assistive technology devices and home accessibility features: Prevalence, payment, need, and trends. Advance Data, No 127. Vital and Health Statistics of the CDC National Center for Health Statistics.
Levitt H. (1971)Transformed Up-Down Methods in Psychoacoustics. J. Acoust. Soc. Am., 49(2), 467-477.
Levitt H, Bernstein C, Bakke M. (2006) Computer assisted tracking, Proc. State of the Science Conference on Hearing Enhancement, Gallaudet University, September 2006. to appear
Nilsson, M., Soli, S. D. & Sullivan, J. A. (1994) J. Acoust. Soc. Am. 95, 1085-1099.
Pollack, D. (1970). Educational audiology for the limited hearing infant: Springfield, Ill.: Charles C. Thomas.
Robbins, H. and Monro S. (1951). A stochastic approximation method, Ann. Math. Statist., 22, 400-407.
Schein, J. D. and Delk, M. T. (1974). The deaf population of the United States. Silver Springs, Md.: National Association of the Deaf.
Schow, R. L. and Nerbonne, M. A. (2002). Introduction to Audiologic Rehabilitation. Boston, Mass.: Allyn and Bacon.
Sims, D. and Gottermeier, L. (2000). Computer applications in audiologic rehabilitation. In J. G. Alpiner and P. A. McCarthy (eds.) Rehabilitative Audiology: Children and Adults. Philadelphia, Pa.: Lippincott, Williams and Wilkins
Sweetow R W, Henderson-Sabes J. (2004). The case for LACE: Listening and auditory communication enhancement training. Hearing Journal, 57(3), 32-36.
Sweetow R, Palmer C V. (2005).Efficacy of individual auditory training in adults: a systematic review of the evidence. J Am Acad Audiol. 16(7):494-504.
Sweetow R W, Sabes J H.(2006). The need for and development of an adaptive Listening and Communication Enhancement (LACE) Program. J Am Acad Audiol. 17(8):538-58.
Walden, B. E., Prosek, R. A., Montgomery, A. A., Scherr, C. K. and Jones, C. J. Effect of training on the visual recognition of consonants. J. Speech Hear. Res., 20, 130-145.
Walden, B. E., Erdman, S., Montgomery, A. A., and Prosek, R. A. (1981).
Some effects of training on speech recognition by hearing impaired adults. J. Speech Hear. Res., 24, 207-216.
Watson C. S. (1987). “Uncertainty, informational masking, and the capacity of immediate auditory memory,” In Auditory Processing of Complex Sounds C. S. Watson, ed. (Hillsdale, N.J.: Lawrence Erlbaum).
Wechsler D. (1981) “The Wechsler Adult Intelligence Scale-Revised.’ (New York: The Psychological Corporation).
Wechsler D. (1987) “Wechsler Memory Scale-Revised.’ (New York: The Psychological Corporation).
Zeng F-G, Nie K, Stickney G S, Kong Y-Y, Vongphoe M, Bhargave A, Wei C, Cao K. (2005). Speech recognition with amplitude and frequency modulations. Proc. Nat. Acad. Sci., 102(7), 2293-2298.

We claim:

1. An auditory training system, comprising:
at least one speech perception activity, and
at least one audio signal, at least one video signal or a combination thereof, wherein the system is user interactive, performance adaptive or a combination thereof.

2. The auditory training system of claim 1, wherein the at least one speech perception activity comprises at least one puzzle, game or combination thereof.

3. The auditory training system of claim 2, wherein the at least one puzzle comprises a cross-sentence puzzle.

4. The auditory training system of claim 1, wherein the system is user interactive and performance adaptive.

5. The auditory training system of claim 1, further comprising at least an amount of interference, distortion or a combination thereof of a speech signal.

6. The auditory training system of claim 5, wherein the at least an amount of interference, distortion or a combination thereof of the speech signal adjusts the difficulty with which speech is perceived.

7. The auditory training system of claim 5, wherein the at least an amount of interference, distortion or a combination thereof of a speech signal comprises at least an amount of background noise.

8. The auditory training system of claim 1, wherein auditory comprises speech perception, speech recognition, cognitive skills, speech skills, language skills or a combination thereof.

9. The auditory training system of claim 1, further comprising at least one instructional item or material focused on the synthetic approach to training.

10. An executable software system, comprising:
at least one speech perception activity, and
at least one audio signal, at least one video signal or a combination thereof, wherein the system is user interactive, performance adaptive or a combination thereof.

11. The system of claim 10, wherein the system is executable on a local system, server-based system or internet-based system.

12. The system of claim 10, wherein the at least one speech perception activity comprises at least one puzzle, game or combination thereof.

13. The system of claim 12, wherein the at least one puzzle comprises a cross-sentence puzzle.

14. The system of claim 10, wherein the system is user interactive and performance adaptive.

15. The system of claim 10, further comprising at least an amount of interference, distortion or a combination thereof of a speech signal.

16. The system of claim 15, wherein the at least an amount of interference, distortion or a combination thereof of the speech signal adjusts the difficulty with which speech is perceived.

17. The system of claim 15, wherein the at least an amount of interference, distortion or a combination thereof of a speech signal comprises at least an amount of background noise.

18. The system of claim 10, wherein auditory comprises speech perception, speech recognition, cognitive skills, speech skills, language skills or a combination thereof.

19. The system of claim 10, further comprising at least one instructional item or material focused on the synthetic approach to training.

20. An auditory training system, comprising:
a computer, internet system, at least one server or another hardware device,
an executable software system that provides at least one speech perception activity, and at least one audio signal, at least one video signal or a combination thereof, wherein the system is user interactive, performance adaptive or a combination thereof and wherein the computer, internet system, at least one server or another hardware device executes the software system to initiate and run the auditory training system.

21. A method of training and improving auditory skills, cognitive skills or a combination thereof, comprising:
providing at least one speech perception activity,
providing at least one audio signal, at least one video signal or a combination thereof, wherein the system is user interactive, performance adaptive or a combination thereof; and
utilizing the at least one speech perception activity in combination with the at least one audio signal, at least one video signal or a combination thereof in order to improve auditory skills, cognitive skills or a combination thereof.

22. A method of training and improving auditory skills, cognitive skills or a combination thereof, comprising:
providing a computer, internet-based system, server-based system or another hardware device,
providing an executable software system that provides at least one speech perception activity,
providing at least one audio signal, at least one video signal or a combination thereof, wherein the system is user interactive, performance adaptive or a combination thereof and wherein the computer, internet-based system, server-based system or another hardware device executes the software system to initiate and run the auditory training system; and
utilizing the computer, internet-based system, server-based system or another hardware device to execute the executable software system that provides at least one speech perception activity in combination with the at least one audio signal, at least one video signal or a combination thereof.
